(19) United States
(12) Patent Application Publication
(10) Pub. No.: US 2026/0303141 A1
(43) Pub. Date: Oct. 1, 2026

(54) Networked device and method for communication between a profile module and a management unit of an integrated circuit card

(71) Applicant: Giesecke+Devrient Mobile Security Germany GmbH, Munich (DE)

(72) Inventors: Eduard Amenedo, El Prat de Llobregat (Barcelona) (ES); Esteban Manuel Perez Drinkovic, El Prat de Llobregat (Barcelona) (ES)

(73) Assignee: Giesecke+Devrient Mobile Security Germany GmbH, Munich (DE)

(21) Appl. No.: 19/576,222

(22) Filed: Mar. 24, 2026

(30) Foreign Application Priority Data
Mar. 27, 2025 (DE) 102025111978.3

(51) Int. Cl. H04B 1/40; H04L 67/025

(52) U.S. Cl. CPC H04B 1/40; H04L 67/025; H04L 2212/00

(57) ABSTRACT

The present disclosure relates to a networked device comprising a management unit, an integrated circuit card comprising a profile module directly integrated into the integrated circuit card and configured to manage mobile radio profiles within the integrated circuit card, and a communication interface between the profile module and the management unit, wherein the communication interface corresponds to a first interface type, wherein the communication interface is configured to wrap a communication according to a second interface type between the profile module and the management unit according to the first interface type to provide a communication function according to the second interface type between the profile module and the management unit. Furthermore, a method for communication between the profile module and the management unit of the integrated circuit card is disclosed.

### CROSS REFERENCE TO RELATED APPLICATIONS

This application claims priority to DE Application No. 102025111978.3 filed Mar. 27, 2025, which is hereby incorporated in its entirety by reference.

### FIELD

The present disclosure relates to a method for efficient communication between a profile module and a management unit on an integrated circuit card.

### BACKGROUND

The communication between a profile assistant on a networked device and an integrated circuit card can take place via a specific interface according to a standard. In particular, an “IoT Profile Assistant” in an IoT device (IPAd) can communicate with an embedded Universal Integrated Circuit Card (eUICC) via a standardized interface, for example ES10. It can be provided that the standardized interface between IPAd and eUICC is not active if, instead of an IPAd, it is a profile assistant integrated on the eUICC, in particular an “IoT Profile Assistant embedded” (IPAe). In particular, the standardized interface can be deactivated for communication between IPAe and components of the eUICC. Existing communication standards, for example SGP.31 and SGP.32, may not include a definition of the communication between IPAe and components of the eUICC.

Communication between the profile assistant and the eUICC can comprise, for example, a bound profile package. With the provision of an IPAe, the communication between IPAe and components of the eUICC can be outside existing communication standards.

Accordingly, it is desirable to develop a general solution which enables the secure and efficient communication between a profile assistant integrated on a circuit card and further components of the integrated circuit card.

### SUMMARY

According to a first aspect, the present disclosure relates to a networked device. The networked device comprises a management unit and an integrated circuit card. The integrated circuit card comprises a profile module directly integrated into the integrated circuit card. The profile module is configured to manage mobile radio profiles within the integrated circuit card. The networked device further comprises a communication interface between profile module and management unit. The communication interface corresponds to a first interface type. Furthermore, the communication interface is configured to wrap a communication according to a second interface type between the profile module and the management unit according to the first interface type to provide communication functions according to the second interface type between the profile module and the management unit.

The networked device according to the invention enables the communication between the profile module and the management unit on the basis of communication functions close to the standard via a specific, jointly usable interface. In particular, it can be validated that only the profile module provided on the integrated circuit card is permitted for the communication.

A networked device can be a physical object that is connected to the Internet and/or other networks. Furthermore, the networked device can be configured to acquire, send and receive data. The networked device can be an Internet-of-Things (IoT) device.

The device can establish a connection to other devices and/or networks by means of communication interfaces such as WLAN, Bluetooth, Zigbee, LoRa and/or cell phone service. The networked device can analyze acquired data and based thereon make decisions and/or execute actions. The networked device can have an interface for remote control, remote monitoring and/or remote maintenance. Control processes, initializations and further tasks or processes can take place according to predefined conditions and/or events.

A networked device can be used in various fields of application, including smart homes, industrial automation, healthcare, transportation and many others. These devices contribute to optimizing processes and increasing their efficiency.

The management unit can be a security domain, which can be configured to implement specific security policies and mechanisms in order to control and protect access to resources and data. Furthermore, the security domain can be configured to ensure the integrity, confidentiality and/or availability of the information stored in the domain.

The management unit can comprise a profile domain, in particular an Issuer Security Domain profile (ISD-P), which can serve as a container for profiles of a mobile radio operator. The management unit can be configured to enable secure management and storage of operator profiles on an integrated circuit card, in particular an eUICC.

The management unit can further comprise a root domain, in particular an Issuer Security Domain root (ISD-R), which can be configured to create and/or manage new instances, in particular new ISD-P instances. The root domain can further be configured to ensure that only authorized entities can add new profiles and/or change existing profiles.

The management unit, in particular the ISD-R, can act as a central management unit for the eUICC and ensure that security policies and protocols are complied with. The management unit can be configured to manage, create, install, activate and/or delete profiles.

Furthermore, the management unit can be configured to ensure the security of the integrated circuit card by implementing and maintaining security measures. The management unit, in particular the ISD-R, can be configured to perform authentication processes to ensure that only authorized entities can access the integrated circuit card.

The management unit, in particular the ISD-R, can be configured to manage cryptographic keys which are used for the encryption and authentication. Furthermore, the ISD-R can be configured to control access to various functions and data within the integrated circuit card in order to prevent unauthorized access.

The management unit can comprise a storage module configuration, in particular a storage module configuration (SMC). The SMC can relate to the configuration of a storage module within the integrated circuit card. The SMC can define how storage resources are organized and managed within the integrated circuit card. This can comprise, for example, the storage of SIM profiles and/or of cryptographic keys.

The integrated circuit card can be, in particular, an embedded Universal Integrated Circuit Card (eUICC). The integrated circuit card can be configured to store and manage a plurality of mobile radio provider profiles. In particular, the integrated circuit card can be configured to be managed remotely by means of a wireless interface.

The integrated circuit card can be embedded on a device, for example a smartphone, or IoT device. Furthermore, the integrated circuit card can comprise program modules (software) which are designed for the management of mobile communication provider profiles. Accordingly, profiles can be provisioned, activated and/or deactivated via remote access by means of the program modules.

The profile module can be a profile assistant, in particular an “IoT profile assistant”, which is configured to provide and manage mobile radio profiles on IoT devices. The profile module can be specified according to an SGP standard, advantageously according to the SGP.31 and/or SGP.32 of GSMA. According to the standard, the architecture and/or requirements for the remote management of integrated circuit cards in networked devices can be defined. In this case, restrictions in relation to a user interface and/or a network can be defined.

Advantageously, the profile module is an “IoT Profile Assistant embedded” (IPAe). Accordingly, the profile module can be directly integrated into the integrated circuit card and configured to manage profiles within the eUICC. The profile module can be configured to securely store profiles, to execute an activation and/or deactivation of mobile radio profiles. Furthermore, the profile module can be configured to communicate directly with the management unit (ISD) and/or other components of the integrated circuit card in order to manage and/or update profiles.

The profile module can be configured to use specific interfaces (e.g. ES10a, ES10b) in order to communicate with other components within the eUICC. The profile module can be configured to communicate with further components, in particular with the management unit, via an internal interface of the integrated circuit card.

The profile module can be configured to manage bootstrap and/or operating profiles. Furthermore, the profile module can be configured to execute the communication and profile transactions in encrypted form in order to ensure the integrity and confidentiality of the data. The profile module can be configured to enable remote management of profiles via external, in particular standardized, interfaces. Advantageously, communication similar to the ES10 standard is used for the communication between the profile module and the integrated circuit card. This enables the secure transmission of profile information and management commands.

The communication interface can be a specialized interface within the architecture of the integrated circuit card, which is provided for the communication between the embedded profile module (IPAe) and management units (for example ISD-R and ISD-P). The communication interface realizes secure and efficient management of mobile radio profiles on the integrated circuit card.

The communication interface can be defined on the basis of the ES10 standard. Accordingly, the communication interface can be configured to support a plurality of communication protocols which are provided for the secure transmission of data between the profile module and the management unit. These protocols can ensure the integrity and confidentiality of the transmitted data by implementing encryption and authentication mechanisms.

The communication interface can be configured to enable bidirectional data transmission between the profile module and the management unit. This can comprise the downloading, activation, deactivation and/or deletion of mobile radio profiles. The communication interface can further comprise encryption and/or authentication to ensure that only authorized entities can access the profiles and/or management commands. The communication interface can be configured to provide a communication tunnel which enables the communication according to a second interface type, in particular according to a standardized interface type (e.g. ES10a/b) between the profile module and the management unit.

The communication interface can be seamlessly integrated into the eUICC architecture. The interoperability between various devices and networks can be ensured by using standardized protocols and interfaces.

According to the specifications SGP.31 and SGP.32 of GSMA, no specific communication standard is defined for the interface between the profile module, in particular the embedded profile assistant (IPAe) and the management module, in particular the security domains (ISDs) of the integrated circuit card (eUICC). This interface falls explicitly outside the scope of these standards. Method sequences for eUICCs in IoT devices differ in relation to the integration of the profile module (IPA). In this case, the profile module can be provided outside the integrated circuit card as IPAd or within the integrated circuit card as IPAe. Flow diagrams can be independent of the integration variant of the profile module. ES10 calls between a profile module (IPAd) located on the networked device and not on the integrated circuit card, in the case of a profile module provided on the integrated circuit card, become internal calls which take place outside the scope of this specification. These internal calls are explicitly excluded from the standard. The standard defines ES10a for use between a profile module (IPAd) located on the networked device and the integrated circuit card in order to perform profile registration according to SGP.31. Furthermore, ES10b is used for the communication between the profile module (IPAd) located on the networked device and profile module services in order to transmit a bound profile package to the integrated circuit card, as defined in SGP.31. This interface plays no role in the decryption of profile packages.

Since the interface between IPAe and ISDs is not covered by the existing standards, the present disclosure defines a new communication interface.

The networked device can be configured to trigger the profile module by an internal event (e.g. the expiry of a timer), in particular without knowledge about an upcoming profile package (e.g. an eIM package). The profile module can be configured to be informed about an upcoming profile package by a push notification. For example, an eIM (Enterprise Information Management) or a backend system of a device manufacturer of the networked device can notify the profile module about an upcoming profile package via a separate communication channel.

The profile module can retrieve connectivity parameters of a currently activated profile from the integrated circuit card. The retrieval of the connectivity parameters by the profile module can be implementation-specific for the integrated circuit card.

The communication interface can be configured to wrap existing communication protocols according to the second interface type (e.g. ES10) to enable the communication between the profile module and the management unit according to the second interface type standard, in particular without actually implementing the second interface standard between the profile module and the management unit. This achieves in particular the advantage that direct use of a communication according to the second interface standard can be prevented. The communication interface can be configured to package messages according to the second interface type in an additional protocol frame according to the first interface type. This frame can be configured to meet the specific requirements of the internal communication within the integrated interface card.

Accordingly, existing protocols according to the second interface type can be used so that changes to an existing infrastructure can be minimized. Compatibility in relation to a communication according to the second interface standard can be enabled and seamless integration can be realized.

The first interface type can ensure the authentication and encryption of the messages. The protocol frame can contain header information which enables the identification and processing of the messages within the integrated circuit card.

According to the present disclosure, a new communication interface according to the first interface type can be defined which is configured to structurally and functionally realize an interface according to the second interface type. In this case, the communication interface can be configured specifically for the internal communication between the profile module and the management unit within the integrated circuit card.

In one embodiment, the management unit can be integrated into the integrated circuit card. Furthermore, the first interface type can differ from the second interface type. The communication interface can be configured to transmit communication commands according to the second interface type.

Advantageously, the management unit and the profile module are integrated into the integrated circuit card. Communication between the management unit and the profile module can be non-standardized and/or non-standardized. Accordingly, the communication can be implemented in a user-specific and/or manufacturer-specific manner. According to the invention, a mapping of standardized functions takes place by means of a non-standard interface. Accordingly, the communication interface can be configured to provide a communication frame according to a standardized interface definition by means of a non-standard interface. With the integration of the management unit into the integrated circuit card, security functions of the integrated circuit card can be applicable to the management unit. In particular, the management unit and the profile module can be located in the same security environment. The communication interface can be configured to provide standardized functions according to an ES10 interface between the profile module and the management unit. In this case, the ES10 functions can be embedded in a further protocol frame which controls the transmission between profile module and management unit.

In one embodiment, the second interface type can comprise a remote access protocol.

Advantageously, the remote access protocol can comprise a standardized protocol for a remote management interface and/or a remote provisioning interface for managing and providing profiles and services on integrated circuit cards.

A remote management interface (RMI) can enable the remote management of the integrated circuit card. It can comprise the protocols and mechanisms which are required to perform administrative tasks such as updating software, changing configurations and/or monitoring the system status. A remote provisioning interface (RPI) can enable the remote provision of profiles and services on the integrated circuit card. This can comprise a downloading, activation, deactivation and/or deletion of mobile radio profiles. Since the integrated circuit card stores sensitive information such as mobile radio profiles and/or authentication data, robust security protocols are required. These protocols ensure that all communication and management processes are secure and protected against unauthorized access.

In one embodiment, the communication interface is configured to establish a communication link restricting a communication within the integrated circuit card to the management unit and to the profile module.

Technically, the eUICC enables the remote provision of mobile radio profiles, which simplifies and speeds up the management and updating of network operator profiles. Devices can change the network operator without having to physically exchange the SIM card, which improves the connectivity and ensures that devices remain connected continuously. Furthermore, the eUICC enables zero-touch connectivity, in which devices can function immediately after installation, since their connectivity is managed remotely. This is particularly important for IoT applications, in which a fast and efficient connection is required.

The restriction of the communication interface to the profile module, in particular the IPAe and other eUICC components, offers several specific advantages. For example, it increases the security, since the risk of unauthorized access is minimized. External interfaces are potential points of attack, and therefore the internal communication improves the security of the stored profiles and data. Furthermore, the internal communication between the IPAe and other eUICC components enables more efficient management of the mobile radio profiles. This reduces latency times and improves the responsiveness in profile management. Also, the energy consumption can be reduced, since the IPAe is directly hosted on the eUICC and no additional communication layers are required. The use of a separate interface ensures for the external communication that the eUICC functions independently of the operating system of the device. This facilitates the integration into various devices and platforms without requiring adjustments to the operating system. Finally, the reliability of the eUICC is increased by the separation of the internal and external communication interfaces. Internal processes can run independently of external disturbances or communication problems, which improves the overall stability of the system.

Furthermore, external access to a possibly non-standard compliant communication interface can be prevented. Nevertheless, the interface can map standard compliant functions so that there is high compatibility with communications which can be directed to the profile module from external sources.

In one embodiment, the communication interface can be configured to provide a communication tunnel for a communication according to a second interface type (ES10a/b) between the profile module and the management unit. A communication tunnel can relate to a special type of communication link within the integrated circuit card. The tunnel can be configured to restrict the communication to the profile module and the management unit.

With a tunnel hierarchically arranged above the communication according to the second interface type, an additional encryption layer can be realized.

The functions according to the second interface type (for example ES10 functions) can be addressed to the management module via a secure channel, or the interface according to the first interface type. The channel is established between the profile module and the management unit. Functions according to the second interface type can originate outside the profile module. For example, external calls (for example from an SM-DP+) can be passed via the profile module to the management unit. Further switching communication units can be connected between the external instance so that a communication can be routed via a plurality of tunnels.

In one embodiment, the communication interface comprises a wrapper configured to map a communication function according to the second interface type into a communication function according to the first interface type. The management unit can be configured to extract the communication function according to the second interface type and to process the communication function according to the second interface type.

The wrapper can be configured to switch between the communicating instances. Accordingly, the communication between the profile assistant and the management unit can be facilitated since compatibility between different protocols can be achieved.

The wrapper can be configured to realize deterministic, authenticated encryption which ensures both the confidentiality and the integrity of the data. The wrapper can furthermore be configured to restrict access to the wrapped function to the recipient. For example, the profile module can serve as an intermediary of the functions and/or response data, in particular without direct access to these functions and/or response data.

According to a further aspect, the present disclosure relates to a method for communication between a profile module and a management unit of an integrated circuit card. In one embodiment, the method can comprise the step of sending a data packet request by means of the profile module to a management system. This function can be used by the profile module to retrieve a configuration package (for example an “eSIM IoT Manager package” or eIM package). For this purpose, the profile module can provide a unique identification number (for example the EID) as input for the function call. The profile module can inform the management system that one or more changes have occurred in the integrated circuit card (e.g. list of profiles, profile status etc.). Thereupon, the management system can update existing information about the integrated circuit card.

The management system can identify the integrated circuit card on the basis of the unique identification number when receiving the data packet request and check whether a configuration package is available for the identified integrated circuit card.

The management system can be an Enterprise Information Management (EIM) which is configured to manage and/or secure profile state management operations (PSMOs) within the integrated circuit card. The management system can cryptographically authenticate PSMOs in order to prevent malicious activities and to ensure that IoT fleet owners receive a verifiable confirmation of the status of each PSMO from a trustworthy integrated circuit card.

The communication between the profile module and the management system can be realized by means of a communication interface according to a third interface type, in particular according to an ESipa interface.

A secure transmission of eSIM profiles between the management system and the profile module can be realized with the data packet request so that profiles can be supplied and managed securely and correctly to the networked device.

In one embodiment, the method can comprise the step of providing a data packet response by means of the management system to the profile module.

The data packet response can be transmitted to the profile module. The profile module processes the data packet. In particular, the profile module can be configured to forward the data packet to the integrated circuit card.

The integrated circuit card can process the data packet and prepares a result response to the request according to the data packet response. The result response can be sent from the integrated card to the profile module.

With the provision of the data packet response, a profile retrieval or the provision of secure transport for eSIM profile delivery can be provided.

In one embodiment, the method can comprise the step of requesting a function according to the second interface type by means of a message according to the first interface type from the profile module to a management unit.

In one embodiment, the method can comprise the step of sending a response length in response to the requesting of a function by means of the management unit.

In one embodiment, the method can comprise the step of sending a response retrieval function corresponding to the response length according to the second interface type by means of a message according to the first interface type by the profile module.

In one embodiment, the method can comprise the step of sending response data in response to the sending of the response retrieval function by means of the management unit.

Thus, a query cycle can be started in order to iteratively acquire data and finally send a result packet to the management system, which comprises the acquired data. Advantageously, the function can be a standardized function, which triggers the sending of a response at the recipient, for example the management unit. The function can be parameterized with the previously queried response length in order to thus obtain a correct query response.

A data transfer between profile module and management unit can be a two-stage process, in which both response data (for example “return data”) and reporting data (for example “notification data”) are retrieved.

In one embodiment, the sending of a response retrieval function and/or the sending of response data can be iteratively repeated until all retrievable response data are received.

In one embodiment, the method can comprise the step of requesting a notification by means of a message according to the first interface type from the profile module to the management module.

In one embodiment, the method can comprise the step of sending a sequence list in response to the requesting of a function by means of the management unit.

In one embodiment, the method can comprise the step of sending a notification retrieval function corresponding to the sequence list by means of a message according to the first interface type by the profile module.

In one embodiment, the method can comprise the step of sending notification data in response to the retrieving of the function response by means of the management unit.

In one embodiment, the sending of a notification retrieval function and/or the sending of notification data can be iteratively repeated until all retrievable notification data are received.

In one embodiment, the method can comprise the step of sending a management packet result comprising the notification data and the response data by means of the profile module to the management system.

### BRIEF DESCRIPTION OF THE DRAWINGS

Reference is now made to the attached figures. The exemplary embodiments will hereinafter be described in conjunction with the following drawing figures, wherein like numerals denote like elements, and wherein:

FIG. 1 shows a schematic illustration of the networked device 100 according to an embodiment of the present invention; and

FIG. 2 shows a schematic illustration of the method 200 according to an embodiment of the present invention.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

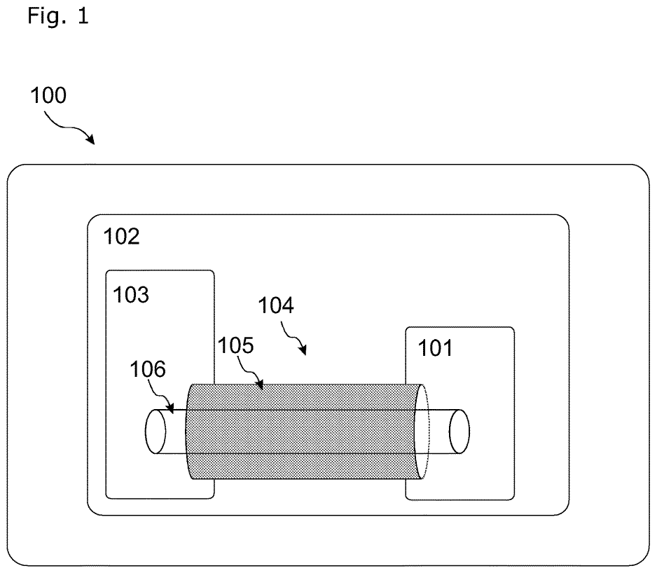

FIG. 1 shows a schematic illustration of a networked device 100 according to an embodiment. The networked device 100 can be an IoT device with an eUICC as integrated circuit card 102.

The networked device 100 comprises at least one management unit 101, which is responsible for the management and control of the eUICC. Advantageously, the integrated circuit card 102 can comprise a plurality of management units. In particular, the integrated circuit card 102 can comprise an ISD-P and an ISD-R, which are each configured to communicate with the profile module 103 via the communication interface 104. The ISD-P and ISD-R can perform administrative tasks such as updating software and monitoring the system status.

The profile module 103 can be an IoT Profile Assistant embedded—IPAe and is directly integrated into the integrated circuit card 102. It is configured to manage mobile radio profiles within the integrated circuit card 102. This comprises the downloading, activation, deactivation and deletion of mobile radio profiles. The communication interface 104 enables the communication between the profile module 103 and the management unit 101. It corresponds to a first interface type 105 and is thus configured to wrap a communication according to a second interface type 106 between the profile module and the management unit according to the first interface type 104. This means that the communication interface provides communication functions according to the second interface type 106 between the profile module 103 and the management unit 101. In this case, the first interface type can be defined as ES10x which can be configured to transmit communication functions according to a standardized communication interface, in particular an ES interface. Advantageously, communication functions can be transmitted according to an ES8, ES9, ES10 and/or corresponding specifications. For example, ES10b and/or ES10a communication functions can be provided between the profile module 103 and the management units ISD-P and/or ISD-R.

The first interface type 105 differs from the second interface type 106. The communication interface 104 is configured such that it can transmit communication commands according to the second interface type 106. The second interface type 106 comprises a remote access protocol which is used for the management and provision of profiles and services on the eUICC. The communication interface 104 is configured such that it establishes a communication link restricting the communication within the integrated circuit card 102 to the management unit 101 and the profile module 103. In addition, the communication interface 104 can provide a communication tunnel for the communication according to the second interface type 106 between the profile module 103 and the management unit 101.

The communication interface 104 can comprise a wrapper configured to map a communication function according to the second interface type 106 into a communication function according to the first interface type 105. The management unit 101 is capable of extracting and processing the communication function according to the second interface type 106.

By mapping known communication functions by means of a newly defined interface, a communication between profile module and management unit can be mapped efficiently.

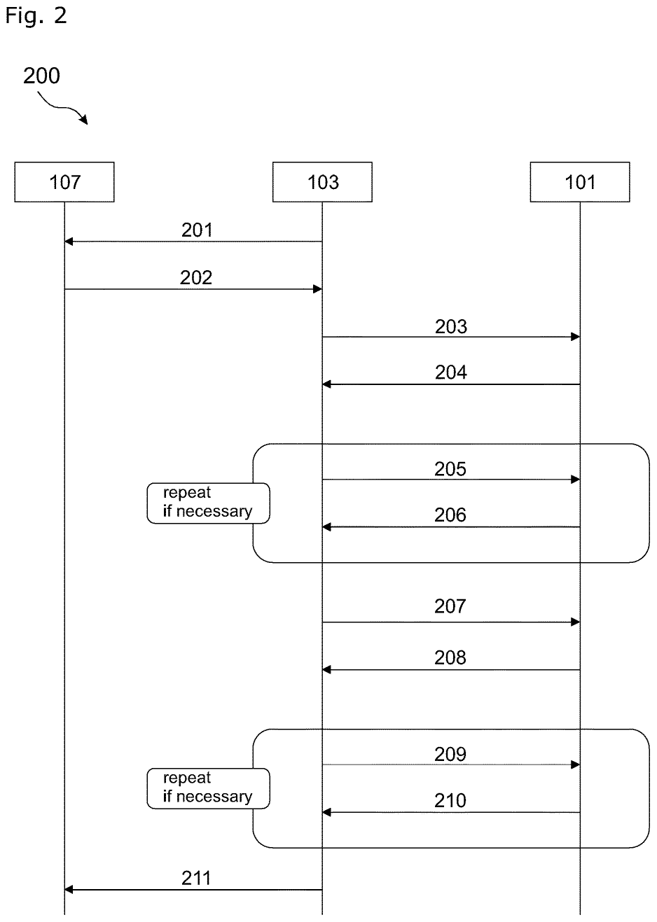

FIG. 2 shows a schematic illustration of a method sequence according to an embodiment of the method for communication with a management unit 101 via a profile module 103 integrated on an integrated circuit card 102. The references of the method steps for communication between the profile module 103 and the management unit 101 of an integrated circuit card 102 are illustrated schematically. The method 200 comprises the following steps: First, the profile module 103 sends a data packet request 201 to a management system 107. This step initiates the communication and requests specific data packets. Subsequently, the management system 107 provides a data packet response 202 and sends this to the profile module 103. This response contains the requested data packets. Subsequently, the profile module 103 sends a message according to the first interface type 105 in order to request a function according to the second interface type 203 from the management unit 101. The management unit 101 thereupon sends a response length 204 in response to the request of the function 203. This response length indicates the size of the data to be transmitted. The profile module 103 sends a response retrieval function 205 corresponding to the response length according to the second interface type 106 by means of a message according to the first interface type 105. This step requests the data transmission. The management unit 101 sends the response data 206 in response to the sending of the response retrieval function 205. These data are transmitted to the profile module 103. The sending of the response retrieval function 205 and the sending of the response data 206 are iteratively repeated until all retrievable response data are received.

Additionally, the profile module 103 sends a message according to the first interface type 105 in order to request a notification 207 from the management unit 101. The management unit 101 sends a sequence list 208 in response to the requesting of the notification 207. This list contains the sequences of the available notifications. The profile module 103 sends a notification retrieval function 209 corresponding to the sequence list by means of a message according to the first interface type 105. This step requests the transmission of the notification data. The management unit 101 sends the notification data 210 in response to the sending of the notification retrieval function 209. These data are transmitted to the profile module 103. Finally, the profile module 103 sends a management packet result 211 comprising the notification data and the response data to the management system 107. This step summarizes the received data and transmits them to the management system.

In an embodiment, the method steps can be defined according to a standardized nomenclature. For example, terms and definitions according to the GSMA SGP.31 and SGP.32 standards can be used:
201—ESipa.GetEimPackageRequest: This is a request which is sent from the profile module IPAe 103 to the Enterprise Information Management EIM 107 in order to request a data packet. This request initiates the process of data transmission.
202—ESipa.GetEimPackageResponse (EuiccPackageRequest): This is the response to the ESipa.GetEimPackageRequest. The EIM provides the requested data packet and sends it back to the IPAe. This response contains the specific data requested by the IPAe.
203—ES10xinterface.requestES10bFunction: In this case, the first interface type can be defined as ES10x. This function is a request which is sent via the ES10x interface in order to request a function according to the second interface type (ES10b). This interface enables the communication between the IPAe 103 and the management unit 101.
204—responselength: This is the length of the response data which is provided by the management unit 101 in response to the requesting of the ES10b function. This length indicates the size of the data to be transmitted.
205—ES10xinterface.retrieveES10bResponse(responseLength): This is the function which is used via the ES10x interface in order to retrieve the response data according to the indicated response length. This function ensures that the data are transmitted correctly and completely.
206—responseData: This is the actual data which is contained in the response and is received by the IPAe 103. This data can comprise various information and profiles.
207—ES10xnterface.requestNotification: This is a request which is sent via the ES10x interface in order to request a notification from the management unit 101. This notification can contain various status or event information.
208—List of sequences: This is a list of sequences which is provided in response to the requesting of the notification. These sequences can represent the order of the available notifications.
209—ES10xnterface.retrieveNotificationBySequence(sequence): This is the function which is used via the ES10x interface in order to retrieve a specific notification on the basis of its sequence. This function can ensure that the notification is transmitted correctly and in the correct order.
210—Notification Data: This is the actual data which is contained in the notification and is received by the IPAe 103. This data can comprise various status or event information.
211—ESipa.ProvideEimPackageResult: This is the result which is sent from the IPAe 103 to the EIM 107 and comprises the notification data and the response data. This result summarizes the received data and transmits them to the EIM.

These terms and their definitions illustrate the various steps and functions which can be used in the communication and data transmission within an eUICC according to the GSMA SGP.31 and SGP.32 standards.

The following functions can further be defined for the communication interface 104:
short requestES10bFunction(byte[]request, short offset, short length, boolean lastBlock)

This method can be an entry point to the ES10b functions defined in SGP.32. The asn1 structures can be encoded according to the specification. If the structure does not fit into the input buffer, a chaining mechanism can be used. The method can be called sequentially, wherein the last block is indicated only in the case of the last call. For retrieving the response, the method retrieveES10bResponse is to be used. The request RetrieveNotificationsListRequest is transmitted with requestNotifications and retrieveNotificationBySequence.
short retrieveES10bResponse(byte[]response, short offset, short length)

This method can be used after the call of requestES10bFunction with lastBlock=true or retrieveNotificationBySequence in order to retrieve the response.

The returned value indicates how many bytes are still missing for reading.
void reset( ):

This method should be called before each request in order to ensure that the previous request is finished.

Since the function retrieveNotificationsList can have a very large response, larger than that of the internal buffer of the SMC, a different approach can be chosen. One method for retrieving the sequence number of the notifications and another method for retrieving each individual notification. The notifications can be smaller than the internal buffer of the SMC.
short requestNotifications(byte[]request, short offset, short length, byte[]outBuffer, short outOffset):
   Method for retrieving the sequence number of the notifications according to RetrieveNotificationsListRequest criteria. The sequence numbers are written as a concatenation of short characters.

Example: SeqNumbers: 001, 0x23, 0x456, 0x7890->buffer {00 01 00 23 04 56 78 90}
short retrieveNotificationBySequence(short sequenceNumber)

Method for retrieving the message with the indicated sequenceNumber. For retrieving the response, retrieveES10bResponse can be used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A networked device comprising:
a management unit,
an integrated circuit card comprising:
a profile module directly integrated into the integrated circuit card and configured to manage mobile radio profiles within the integrated circuit card, and
a communication interface between the profile module and the management unit, wherein the communication interface corresponds to a first interface type,
wherein the communication interface is configured to wrap a communication according to a second interface type between the profile module and the management unit according to the first interface type to provide a communication function according to the second interface type between the profile module and the management unit.

2. The networked device according to claim 1,
wherein the management unit is integrated into the integrated circuit card,
wherein the first interface type differs from the second interface type, and
wherein the communication interface is configured to transmit communication commands according to the second interface type.

3. The networked device according to claim 1,
wherein the second interface type comprises a remote access protocol.

4. The networked device according to claim 1,
wherein the communication interface is configured to establish a communication link restricting a communication within the integrated circuit card to the management unit and to the profile module.

5. The networked device according to claim 1,
wherein the communication interface is configured to provide a communication tunnel for a communication according to the second interface type between the profile module and the management unit.

6. The networked device according to claim 1,
wherein the communication interface comprises a wrapper configured to map a communication function according to the second interface type into a communication function according to the first interface type,
wherein the management unit is configured to extract the communication function according to the second interface type and to process the communication function according to the second interface type.

7. A method for communication between a profile module and a management unit of an integrated circuit card, comprising:
sending a data packet request by means of the profile module to a management system;
providing a data packet response by means of the management system to the profile module;
requesting a function according to a second interface type by means of a message according to a first interface type from the profile module to a management unit;
sending a response length in response to the requesting of a function by means of the management unit;
sending a response retrieval function corresponding to the response length according to the second interface type by means of a message according to the first interface type by the profile module;
sending response data in response to the sending of the response retrieval function by means of the management unit.

8. The method according to claim 7, wherein the sending of a response retrieval function and the sending of response data are iteratively repeated until all retrievable response data are received.

9. The method according to claim 7, further comprising:
requesting a notification by means of a message according to the first interface type from the profile module to the management unit;
sending a sequence list in response to the requesting of a function by means of the management unit;
sending a notification retrieval function corresponding to the sequence list by means of a message according to the first interface type by the profile module;
sending notification data in response to the sending of the notification retrieval function by means of the management unit.

10. The method according to claim 9, further comprising:
sending a management packet result comprising the notification data and the response data by means of the profile module to the management system.
